(19) United States
(12) Patent Application Publication
(10) Pub. No.: US 2013/0178970 A1
(43) Pub. Date: Jul. 11, 2013

(54) METHOD AND SYSTEM FOR PROVIDING MONITORING CHARACTERISTICS IN AN SOA BASED INDUSTRIAL ENVIRONMENT

(71) Applicants: Daniel Cachapa, Frankfurt am Main (DE); Armando Walter Colombo, Hinte (DE)

(72) Inventors: Daniel Cachapa, Frankfurt am Main (DE); Armando Walter Colombo, Hinte (DE)

(73) Assignee: SCHNEIDER ELECTRIC AUTOMATION GMBH, Seligenstadt (DE)

(21) Appl. No.: 13/522,346

(22) PCT Filed: May 4, 2011
(86) PCT No.: PCT/EP2011/057153

§ 371 Date: Jul. 17, 2012

(30) Foreign Application Priority Data
May 4, 2010 (DE) 10 2010 016 764.9

(51) Int. Cl. G05B 19/418

(52) U.S. Cl. CPC G05B 19/41875
USPC 700/108

(57) ABSTRACT

The invention relates to a method and system for providing monitoring characteristics in an industrial environment on the basis of a service oriented architecture (SOA), for the purpose of allowing monitoring of changes in state of a process and/or of production equipment of an industrial plant. The changes in state are obtained by analyzing feature-based monitoring characteristics provided as a service by components of the industrial plant to be monitored as monitoring components. Service orchestrators generate new model-based monitoring characteristics using physical or logical rules of a process model. The model-based monitoring characteristics are provided as a service and can be provided by means of a service-oriented network for arbitrary linking in a control system comprising a service orchestrator.

The invention relates to a method for providing monitoring characteristics in an SOA-based industrial environment for the purpose of monitoring changes in state of a process and/or production means of an industrial plant, wherein the changes in state are obtained by analyzing feature-based monitoring characteristics, such as sensor signals, which are provided as services (S1 . . . Sn) by components to be monitored as monitoring components, such as sensors of the industrial plant, and to a system for carrying out the method according to the preamble of claim 15.

A method and a system for providing monitoring characteristics in an SoA-based industrial environment is known, for example, from the prior published art D. Cachapa et al: “SoA-based Production Monitoring Systems for Energy Efficiency: A Case-study Using Ford's POSMon System”, ICIT Conference, Mar. 14 to 17, 2010. Proceeding from a known production monitoring system, the Cachapa document describes the use of SoA-based technology to improve the monitoring of an industrial plant.

A network layout described in the document “D. Cachapa” comprises a company network for connecting control devices such as PLCs, each controlling and monitoring components of the production system.

The network further comprises a plant network, based on TCP/DP, for example, which connects all systems supporting the production operation, such as production databases, alarm detection systems, production overhead displays, to monitoring units, in which data can be analyzed by production engineers. The two networks are connected via a data acquisition server, which forms a bridge between the two networks. So as to improve the known system, notably with the objective of providing monitoring characteristics, an SOA-based architecture is proposed, wherein so-called “smart devices” are designed as service-oriented components which are able to provide monitoring characteristics, for example, as services via a service interface.

The essay J. King et al.: “Atlas: Service-oriented sensor platform” from 2006 and WO 2007/098168 A1 describe a modular platform which allows an automatic integration of heterogeneous devices, sensors and actuators in a heterogeneous network. The system comprises a hardware platform, at least one driver, a variety of devices connected to the hardware platform, a middleware interface and a variety of software services. Each of the variety of devices is selected from a group of sensors and actuators. The variety of software services is generated by at least one driver, wherein a software service is associated with a device and wherein each of the software services communicates with the middleware interface. In addition, a service composer is proposed, which composes services of the sensors which, however, are located in a level of the hardware platform, this being the “physical layer”.

General information about the service-oriented architecture of devices as well as about the communication between service-oriented devices and the use of DPWS (device profile for web services) can be found in the following essays: F. Jammes and H. Smit, “Service-oriented architectures for devices—the SIRENA view,” 3rd IEEE International Conference on Industrial Informatics (INDIN)”, 2005, pp. 140-147 as well as F. Jammes, A. Mensch, and H. Smit, “Service-oriented device communications using the devices profile for web services”, Proceedings of the 3rd international workshop on Middleware for pervasive and ad-hoc computing, ACM New York, N.Y., USA, 2005, p. 1-8.

The essay by D. Cachapa, A. Colombo, M. Feike, and A. Bepperling: “An Approach for Integrating Real and Virtual Production Automation Devices Applying the Service-oriented Architecture Paradigm”, IEEE Conference on Emerging Technologies & Factory Automation, 2007, pp. 309-314, describes an approach for integrating real and virtual production automation devices using the service-oriented architecture.

Modern industrial environments today are subjected to constraints from a variety of areas: governments demand more environmentally friendly and safer products, while consumers demand quality, customer-specific products and low prices. To meet these challenges during times of technological upturn, companies at different levels of the enterprise architecture increasingly rely on smart mechatronics equipment (devices and systems) to take over tasks that previously were performed manually.

The field of manufacturing automation was a trendsetter in this field and, thanks to ever more complex and efficiently operating machines, has undergone drastic developments over the last few years. However, these changes have also resulted in increasingly complex tasks when it comes to maintaining and monitoring these machines. The use of modern manufacturing systems has become an incredibly expensive and time-consuming task, because manufacturing specifications must be converted into machine code connecting all the devices among each other. Similarly, a framework for monitoring must be set up, allowing the manufacturing engineers to gain an overview, in real time, of the status of the smart mechatronics components, the production and information flow, consumption of energy, inventory management and other characteristics which are important for production.

It is anticipated that the event-based, high-ranking and decoupled procedure of production means relying on a service-oriented architecture (SoA) will allow easier integration, configuration and maintenance of the monitoring systems, while also increasing the performance and options over conventional systems. Analyzing monitoring tasks and the energy efficiency in an SoA-based manufacturing automation system must not be limited to merely applying the present state of the art to these areas, but must also develop prototype engineering solutions that demonstrate the proposed methodology. From an engineering point of view, these solutions should be based on existing application cases which represent the current industrial requirements.

So as to approach the problem of how to best use the available new technologies in modern production plants, first an understanding is necessary of the requirements of an energy-oriented production monitoring system. The CACHAPA document describes an analysis of the current monitoring system corresponding to the prior art.

Based on this, it is the object of the present invention to enable the use of an SoA paradigm in conjunction with the availability of increasingly less expensive, smaller and more powerful data processing devices, and notably to considerably improve the current energy-oriented production monitoring techniques.

The object is achieved according to the invention in that the feature-based monitoring characteristics, which are provided as services by the monitoring components of the industrial plant, are orchestrated by means of service orchestrators implemented as software modules in monitoring components and control systems distributed differing levels of the SoA-based industrial environment to form new model-based monitoring characteristics which are not made available by existing monitoring components,

the orchestration of the services is carried out according to one or more physical or logical law(s) of a process model of the industrial plant,

each of the service orchestrators forms a new monitoring component in the SoA-based industrial environment and offers the at least one new model-based monitoring characteristic as a service, and

the feature- and model-based monitoring characteristics offered by the monitoring components at differing levels of the SoA-based industrial environment as services are provided via a service-oriented network for random composition in a control system comprising a service orchestrator.

The method according to the invention and the associated methodology are based on the orchestration of services for the representation of feature- and model-based monitoring characteristics in an SoA-based industrial environment.

The method is preferably characterized in that the orchestration is carried out by the software which is preferably embedded in one or more of the components and forms the service orchestrator.

A further preferred procedure is characterized in that a dedicated orchestration process is carried out for each physical or logical law which is used for monitoring a certain process.

The orchestration is preferably carried out by one or more distributed orchestrators, which is to say by parts of or by the entire software which are or is embedded in one component, or in several components, of the SoA-based architecture.

The software which forms the sensor orchestrator and carries out the orchestration according to a physical or logical law for the process to be monitored is preferably uploaded to the SoA-based component.

According to a further preferred procedure, the physical or logical law is derived from a process model, or is based on the method of qualitative service fusion, and/or the process model preferably comprises model parameters and model properties, wherein the new monitoring characteristics are generated by analyzing the model properties and these new monitoring characteristics are then made available via the web service interfaces which are part of the process-executing components.

The method is further characterized in that feature-based monitoring characteristics of smart sensors are offered as services, wherein smart sensors are such which are equipped with a service interface, which offers sensor data via the SoA-based network, and/or model-based monitoring characteristics are offered as services by the orchestrators according to an orchestration method.

A system for providing monitoring characteristics in an SoA-based industrial environment for monitoring changes in state of a process and/or of production means of an industrial plant is characterized in that the changes in state are obtained by analyzing feature-based monitoring characteristics, such as sensor signals, which are provided as services by components to be monitored as monitoring components, such as sensors of the industrial plant, and the feature-based monitoring characteristics, which are provided as services by the monitoring components of the industrial plant, can be orchestrated by means of service orchestrators implemented as software modules in monitoring components and control systems distributed differing levels of the SoA-based industrial environment to form new model-based monitoring characteristics which are not made available by existing monitoring components,

the orchestration of the services can be carried out according to one or more physical or logical law(s) of a process model of the industrial plant,

each of the service orchestrators forms a new monitoring component in the SoA-based industrial environment and offers the at least one new model-based monitoring characteristic as a service, and

the feature- and model-based monitoring characteristics offered by the monitoring component at differing levels of the SoA-based industrial environment as services are provided via a service-oriented network for random composition in a control system comprising a service orchestrator.

Further details, advantages, and characteristics of the invention will not only be apparent from the claims and the characteristics disclosed therein, either alone and/or in combination with one another, but also from the following description of preferred exemplary embodiments shown in the drawings.

In the drawings:

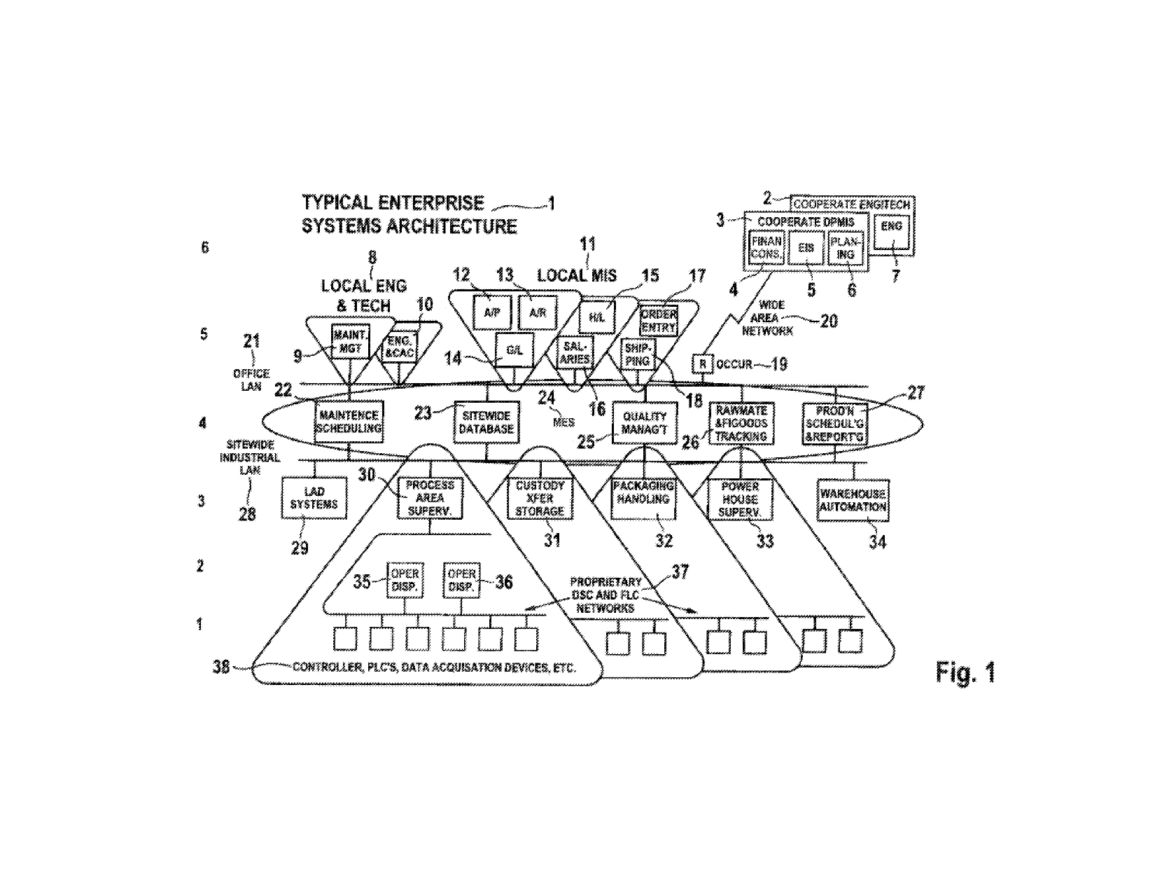

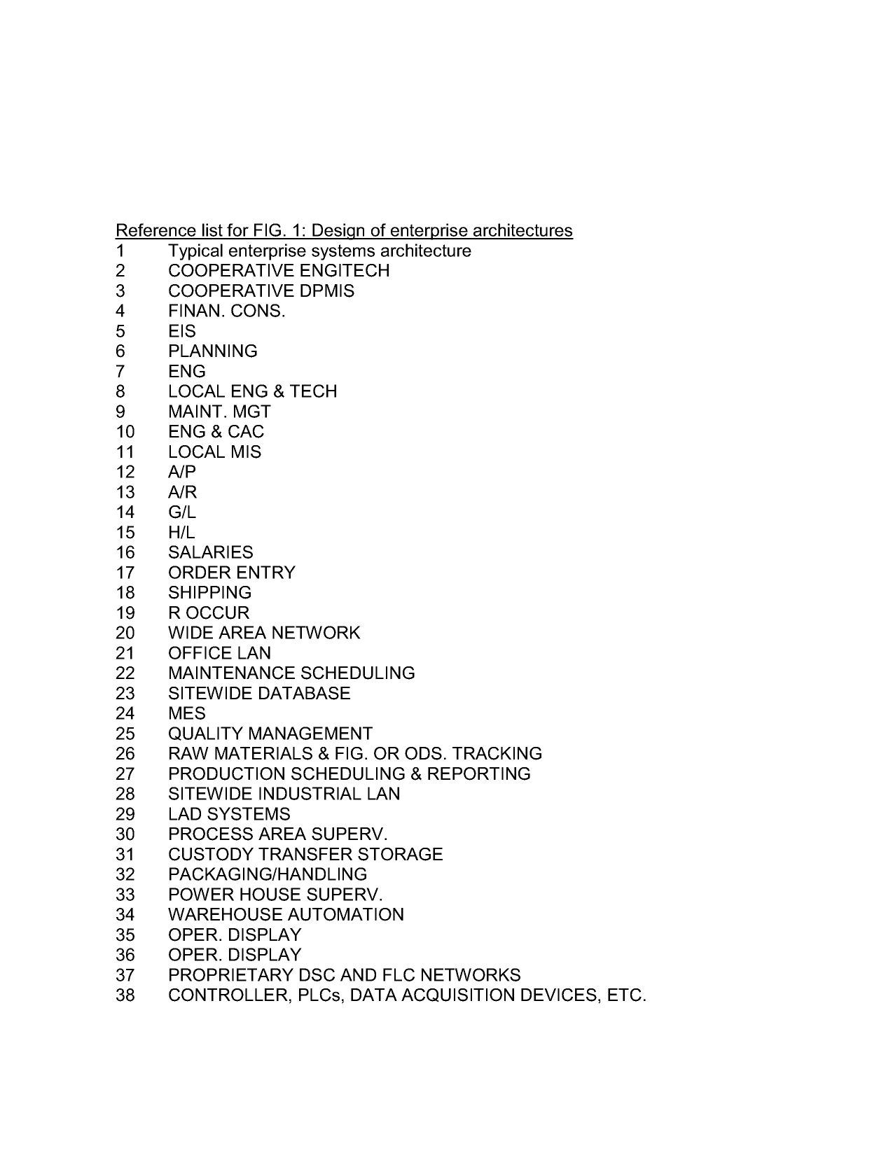

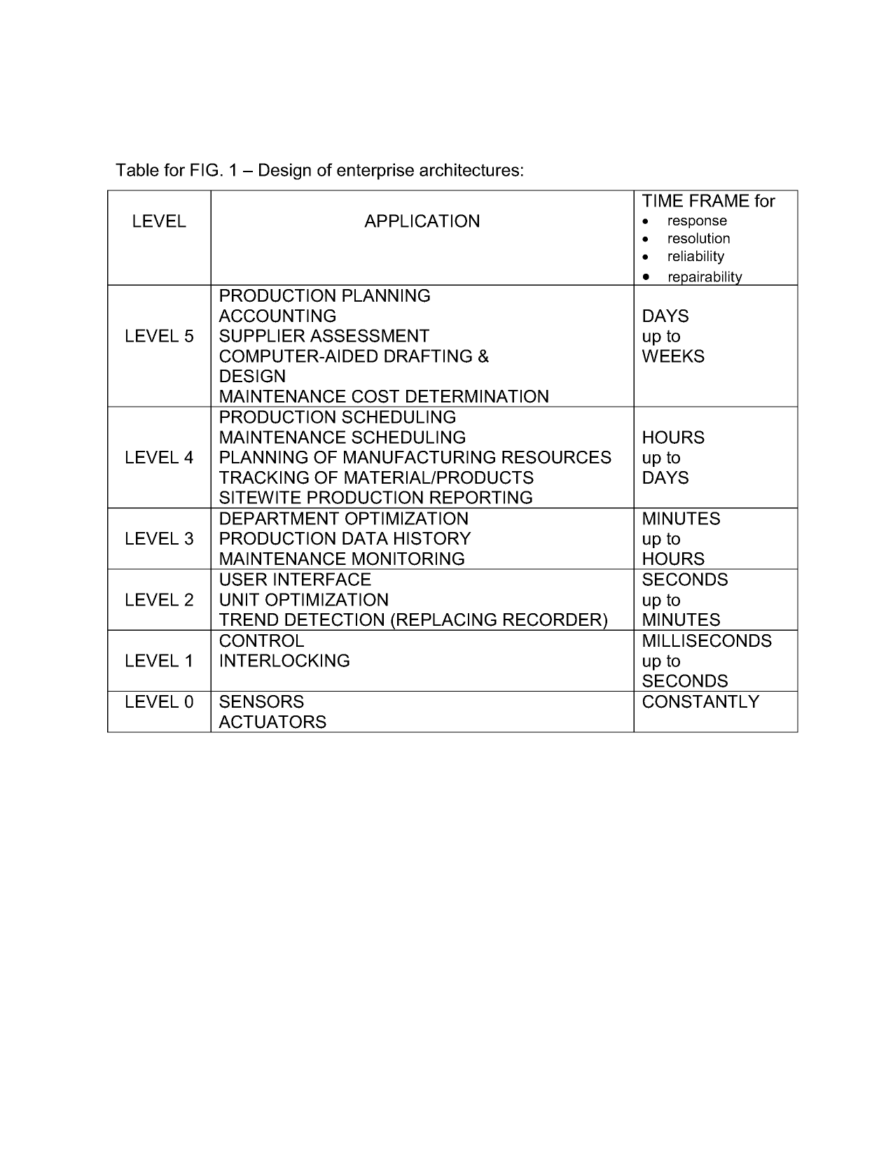

FIG. 1 shows a schematic illustration of an enterprise architecture comprising differing, linked levels having differing response times, such as a manufacturing level and a company level;

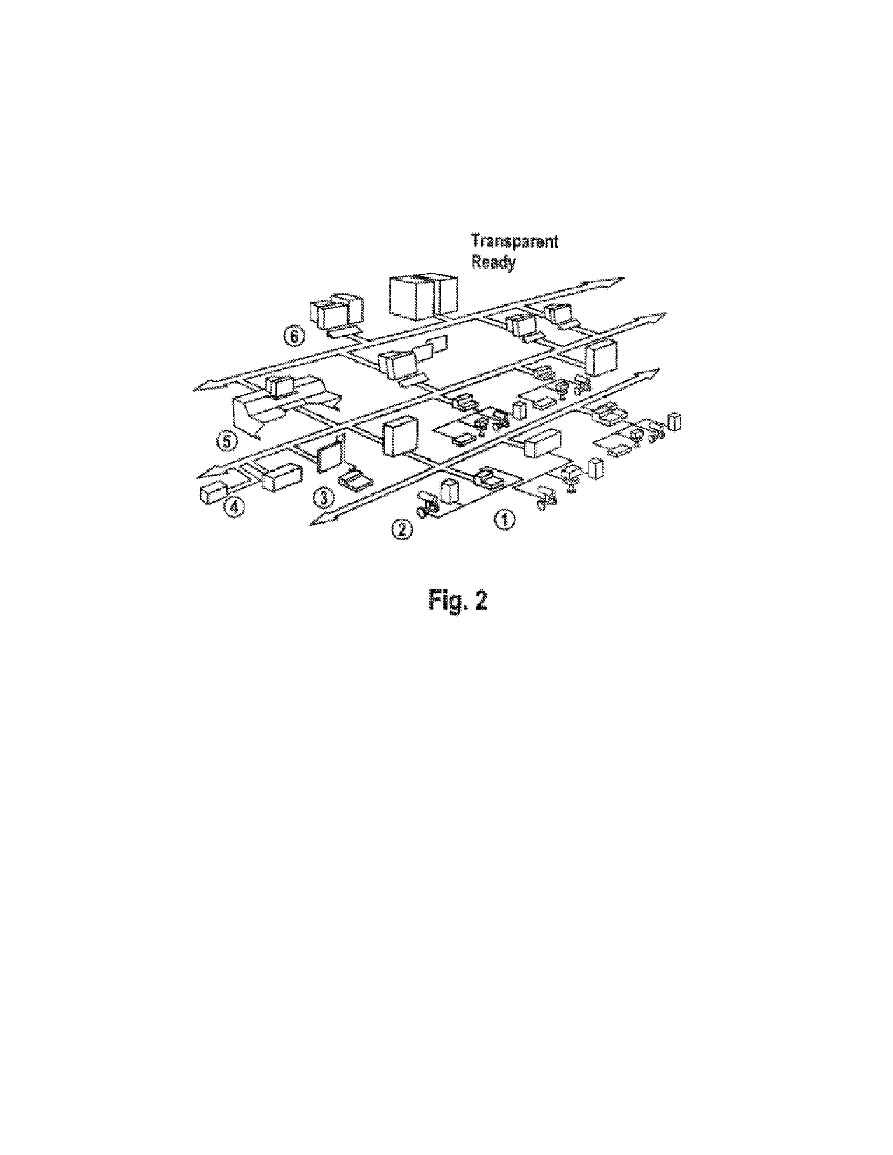

FIG. 2 shows an enterprise system architecture having a flat hierarchy;

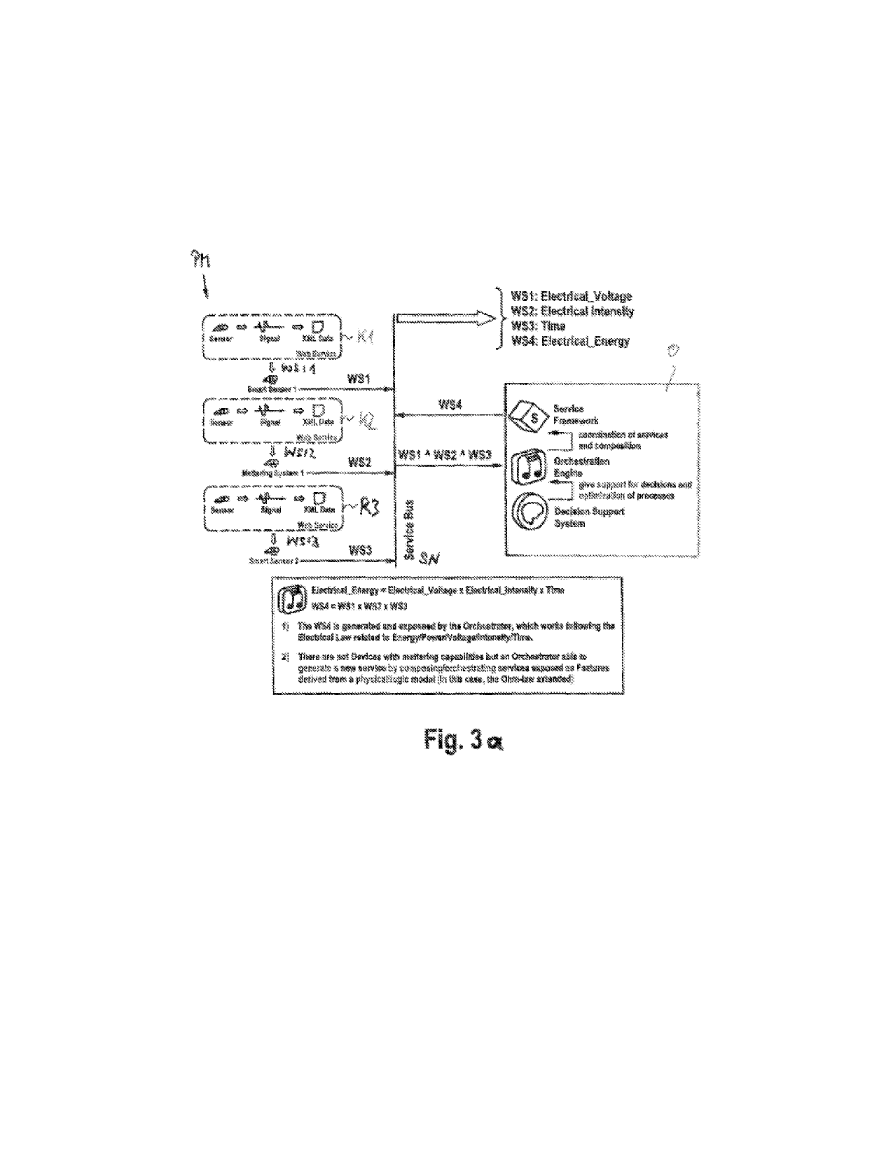

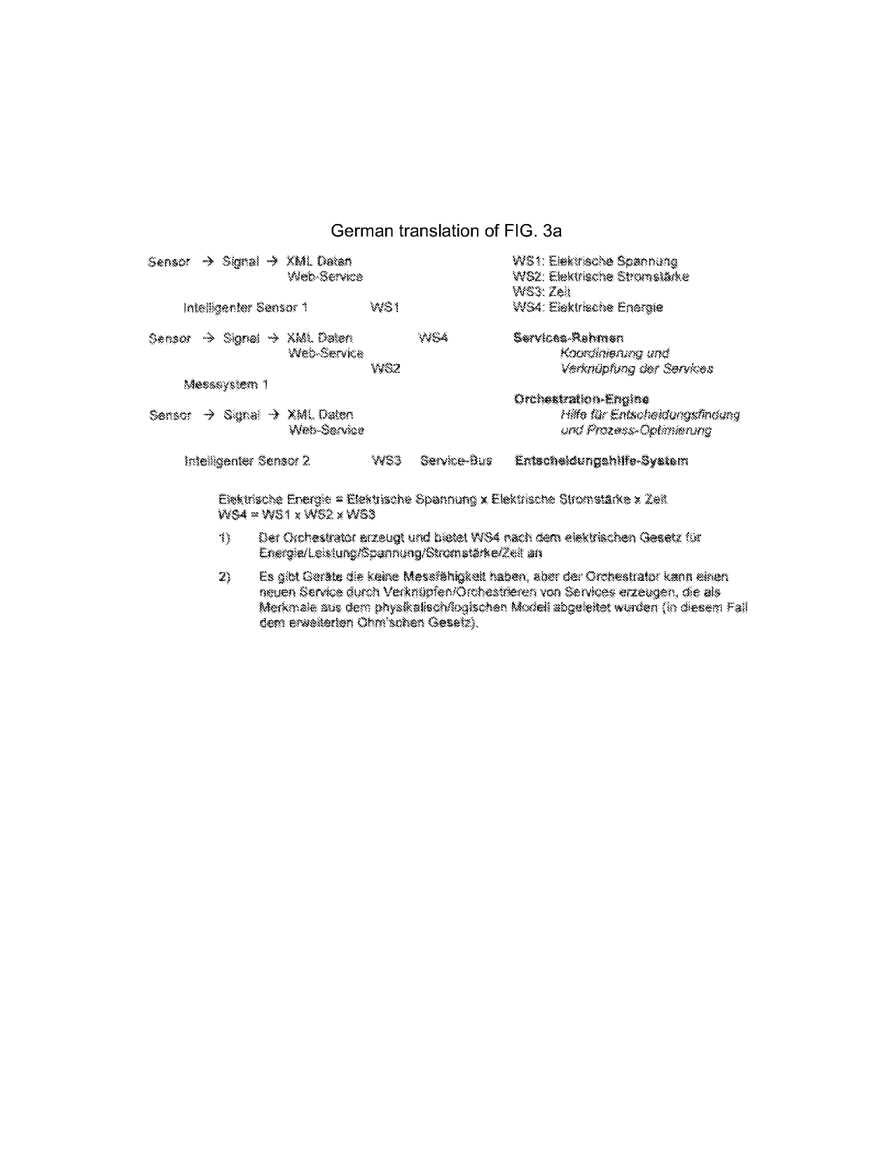

FIG. 3 shows an SoA-based network having monitoring components connected to a service orchestrator;

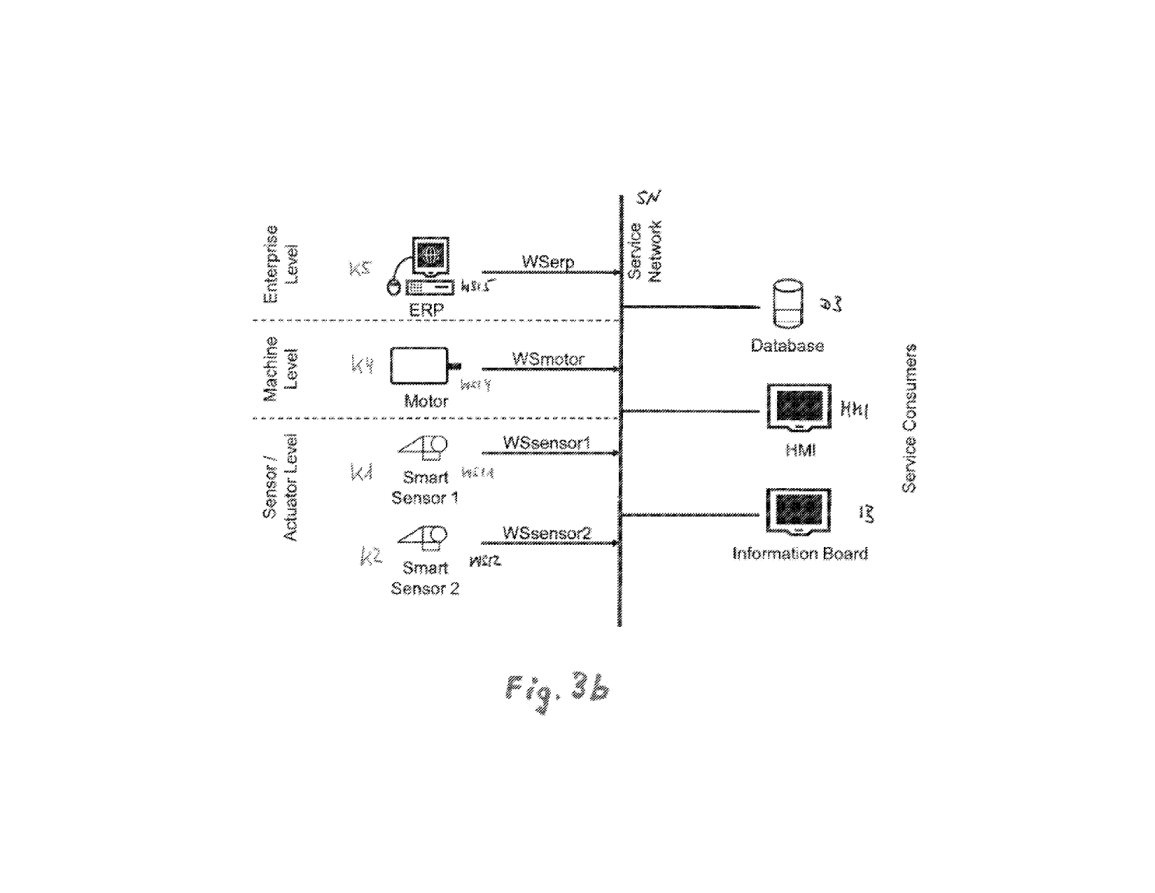

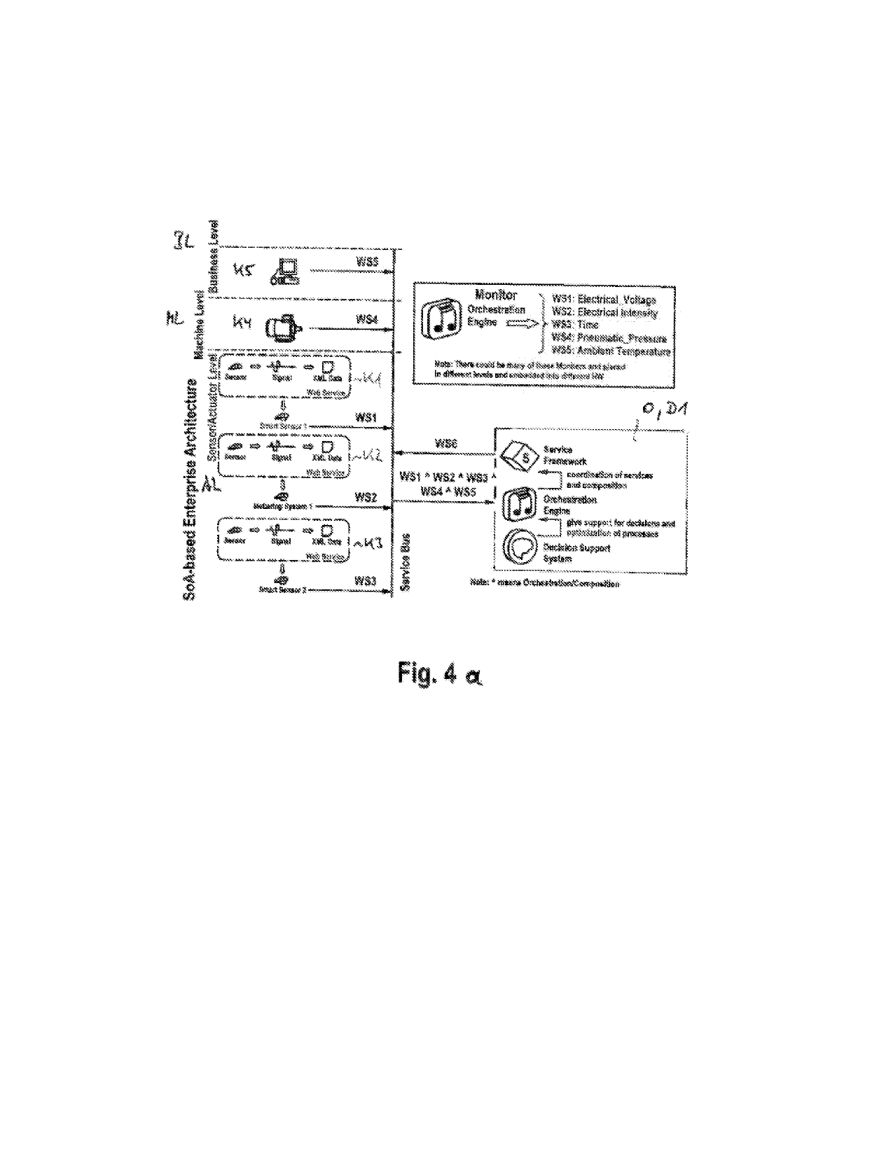

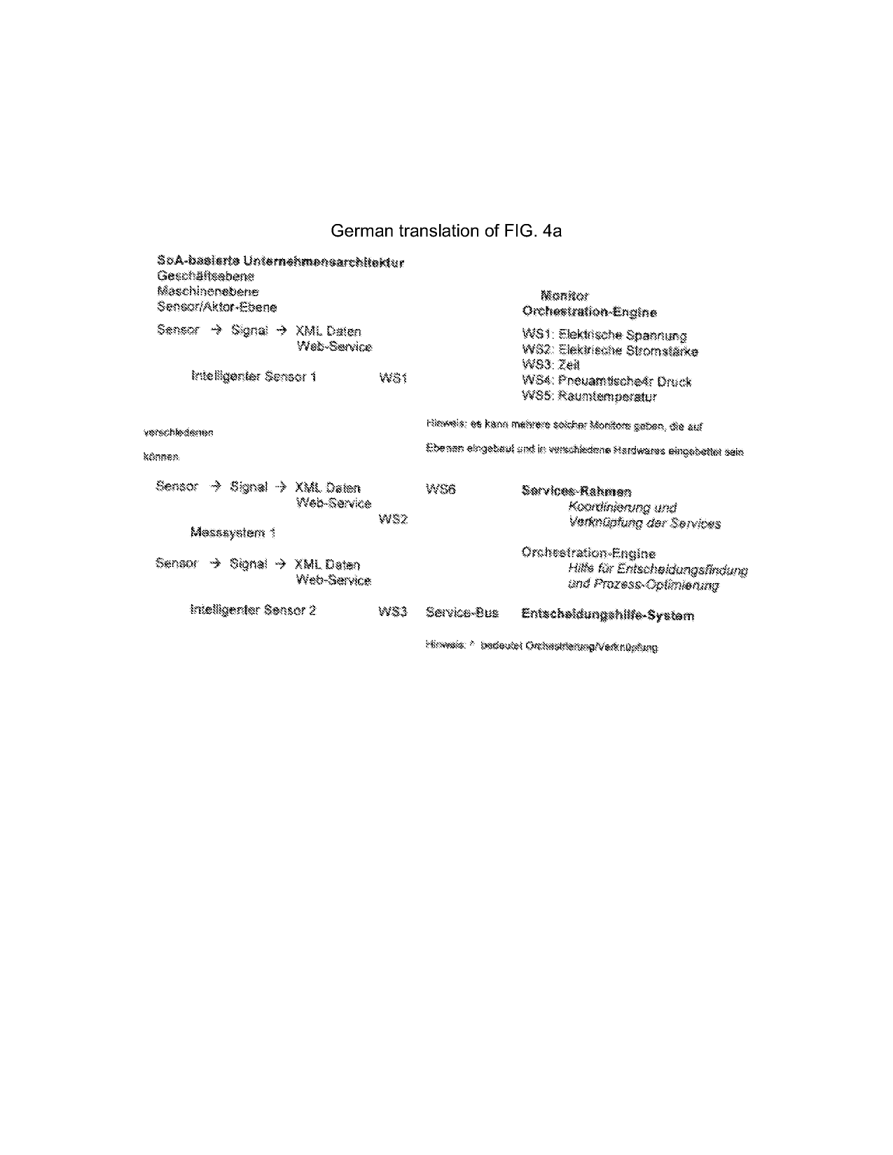

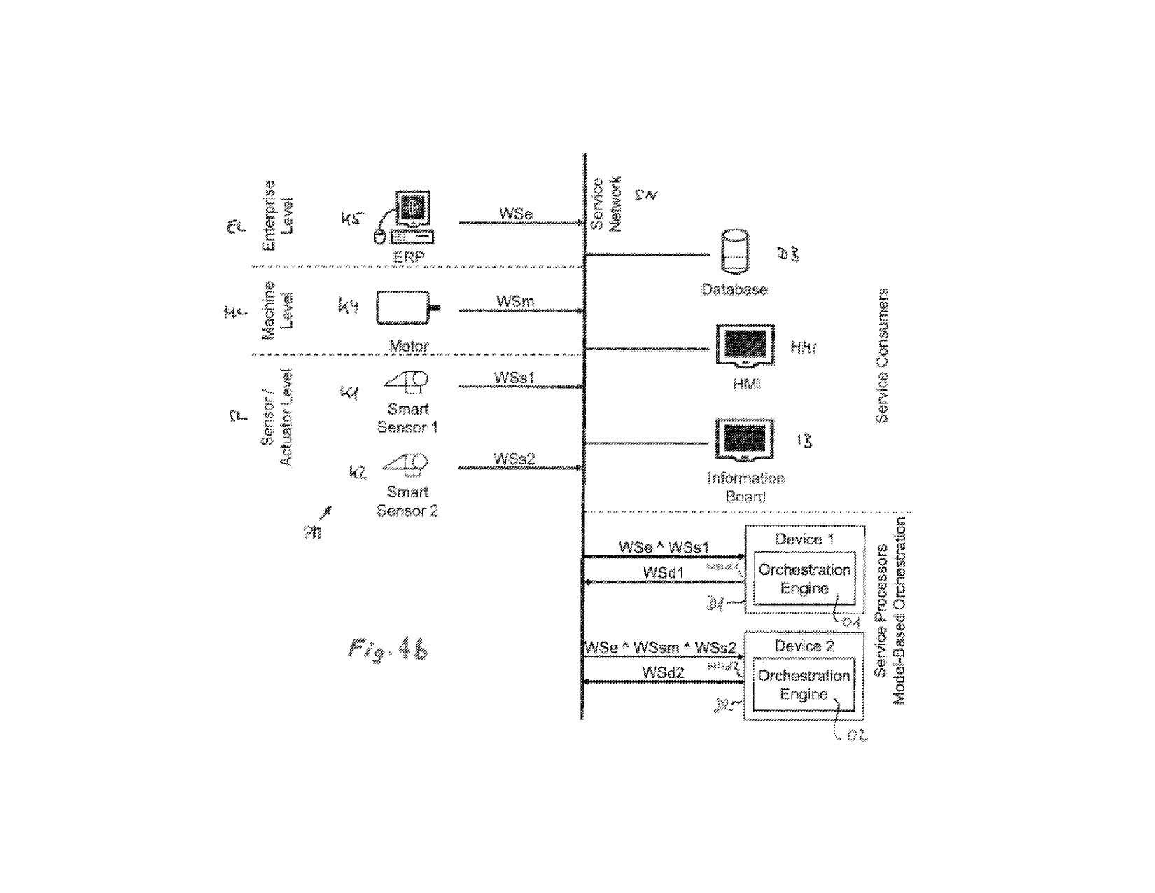

FIG. 4 shows monitoring components of differing levels of an enterprise structure, which are connected to each other via an SoA-based network;

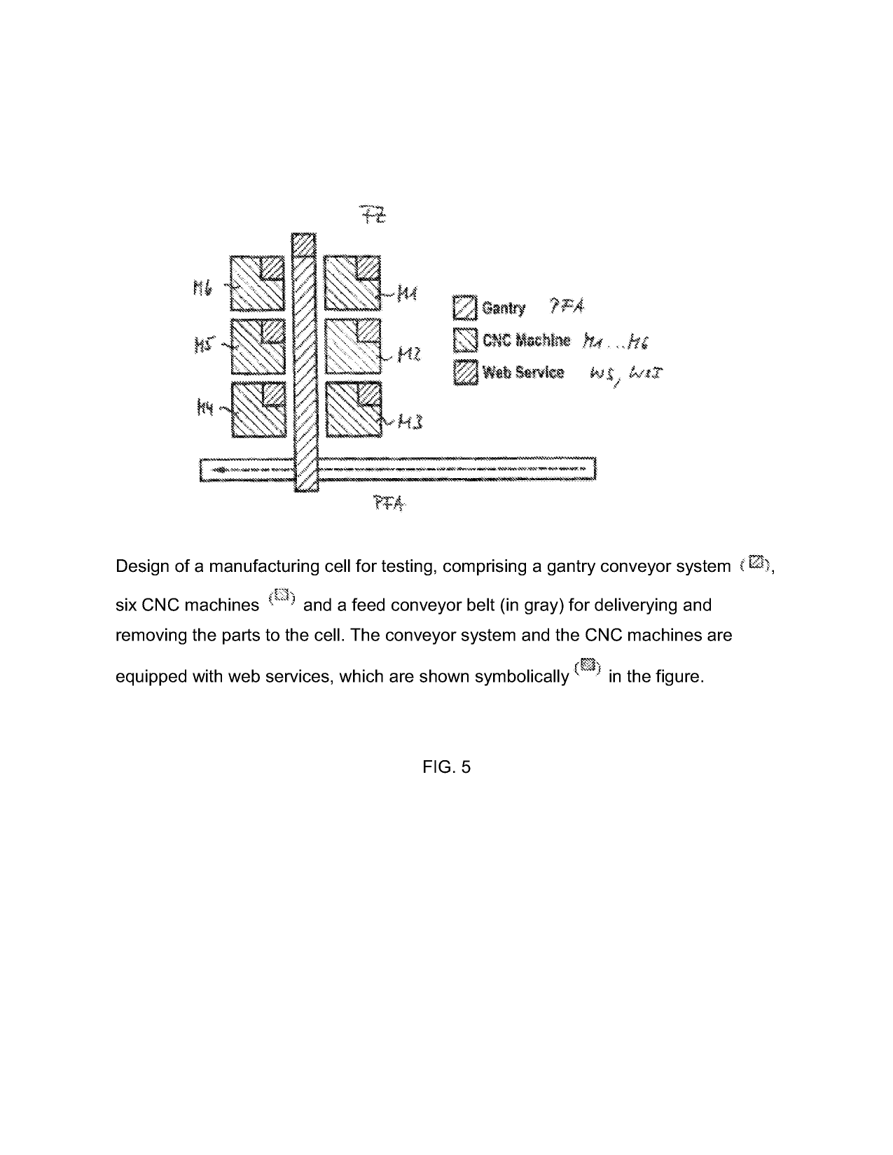

FIG. 5 shows the design of a manufacturing cell; and

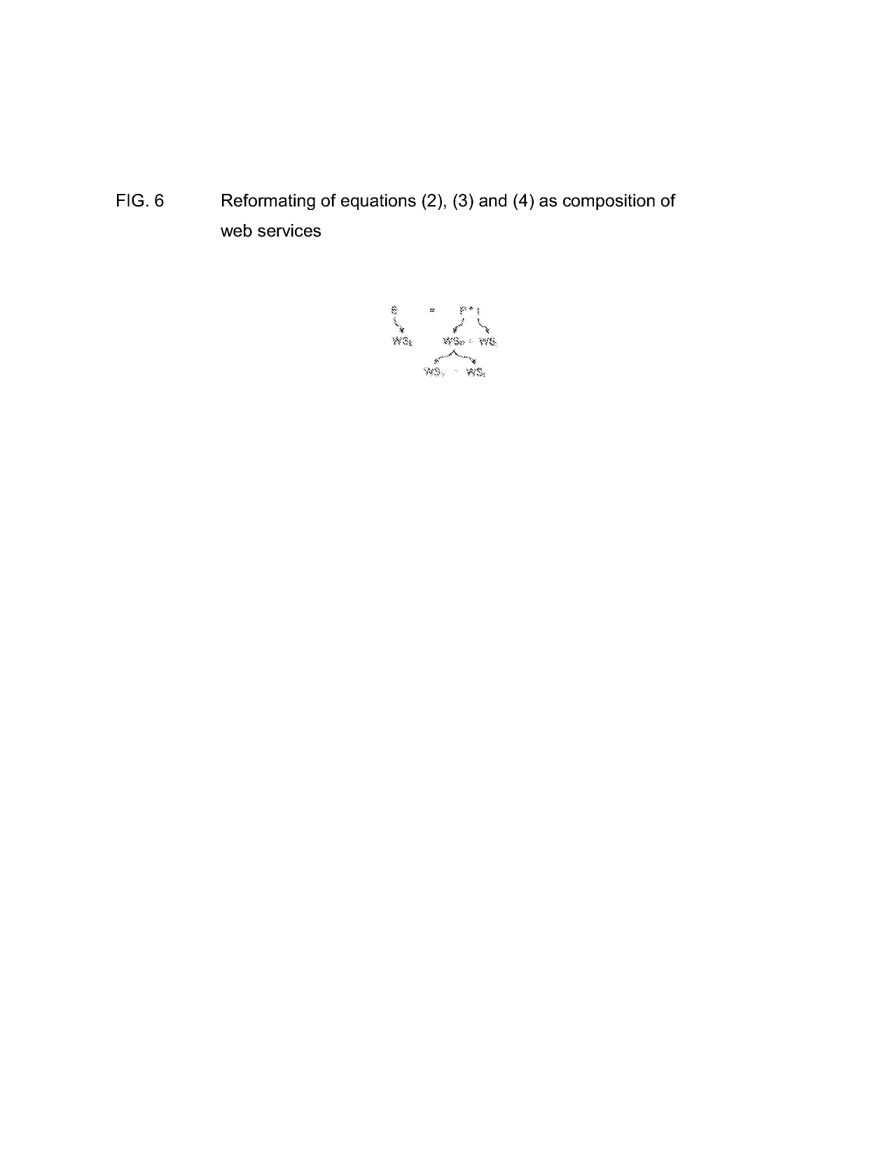

FIG. 6 shows an orchestration of services according to a process model.

The degree of reliability and efficiency of the energy consumption or use when operating industrial plants according to a structure shown in FIG. 1 depends not only on the operation of individual mechatronics or hardware components 38, but also on the structure and the behavior of an embedded higher-level control system 2, 3, 22, 30. Monitoring tasks must be performed at two different and separate, yet linked levels 1, 4, 6, which is to say the manufacturing level and the higher level of the enterprise architecture. At each of these levels, a number of functional and logical components 9, 10, 30, 22 can be identified, which are in charge of carrying out the following functions: data acquisition, collection of information, signal and information processing, decision making, diagnosis and individual monitoring of the events. Each of these levels, which are denoted by numbers 1 to 6 in FIG. 1, has dedicated time targets (from microseconds to days and weeks) and a dedicated area for data and information processing. A comprehensive description of the physical and logical properties of each of these higher-level control levels in an enterprise architecture can be found in: [PERA 2006, Purdue reference architecture. http://pera.net, http://iies.www.ecn.purdue.edu/IIES/PLAI]. See FIG. 1: PERA reference architecture, and FIG. 2: Exemplary Schneider Electric Enterprise system architecture “transparent ready”.

Monitoring the activities, the behavior of the mechatronics or hardware components, and of the system as a whole, is therefore an essential function of such a higher-level control system at every point within the differing levels of the enterprise architecture.

“Monitoring” in the context of the present invention shall be understood to mean the detection of characteristic changes in a process or in the behavior of the mechatronics or hardware resources, which is achieved by analyzing process and component signatures without interrupting normal operation (Du, Elbestawi & Wu, 1995). In general terms, the monitoring of industrial plants usually requires three consecutive phases: First, validating the hardware specifications of the plant and of the associated software control system and implementing these two components (detecting encoding errors). The second step concerns “online data acquisition” and “collecting information”, which are accomplished by analyzing the real-time behavior and the real-time development of the plant and of the embedded control system. Finally, information and sensor signals must be processed so as to obtain a complete and reliable overview in real time of the behavior of the entire industrial plant (Feldmann et al. 1999 and references contained therein). These phases can only be applied if monitoring methods are present which satisfy these necessary functionalities. In general, monitoring methods can be divided into two categories: feature-based and model-based methods (Du et al. 1995). In the case of feature-based monitoring, the behavior of the components and the process conditions can be estimated based on information supplied by sensor/actuator signals and by the process interface (mechatronics information). If models of the industrial plant and of the process are available, the information contained in this model/in these models and the analysis of parameters and properties of the model or models during operation of the plant allow the monitoring functions to be carried out (Feldmann et al. 1999 and references contained therein).

Monitoring an industrial plant, such as a manufacturing cell, necessitates continuous monitoring of the state of this cell over time. This is accomplished by monitoring the relevant characteristics of each mechatronics component forming the plant, and the relationships to each other.

Feature-based monitoring comprises the monitoring of features offered by the production means. Data regarding these features is attained by analyzing signals generated by differing components or monitoring components K1, K2, K3, K4, K5, such as sensors or electrical machines of a production means PM.

The proposed architecture shown in FIGS. 3a, 3b is aimed at taking the signals generated by the hardware K1, K2, K3, enveloping them in an XML format with the expanded associated data, such as a time stamp, and then providing them via a web service interface WSI1, WSI2, WSI3. The information is packaged as an event and is transmitted in real time via a network SN to all interested subscribers such as databases DB, user interfaces HM1 and control systems IB.

This method is repeated for each mechatronics component K1, K2, K3, K4, K5 that is able to support computerized data processing. If such components are equipped with a web service function, they can be considered SOA-based components or smart devices comprising an integrated web service WS1, WS2, WS3, WSerp, WSmotor.

When this method is expanded to all components of the production plant, a smart plant comprising embedded web services WS1, WS2, WS3, WSerp, WSmotor is attained.

When one of the smart devices K1, K2, K3 makes the data thereof available as a web service WS1, WS2, WS3, or 51, S2, S3 which relates to features such as sensor signals, measured data and the like, this service is recognized as a feature monitoring characteristic, for example Sᵢ.

The set of services (S₁ . . . Sₙ) available in a device or a manufacturing cell can be used and combined to form more complex features, for example a sensor fusion coupled by service composition. The result then forms a new monitoring characteristic.

F₁=S₁·S₂·S₃· . . . ·Sᵢ· . . . ·Sₙ (1)

The composed service F₁ is the result of applying a relation to the available set of services. This relation is applied implicitly during the composition of the features supplied by the individual sensors that are present.

For this purpose, it is necessary for a processor which is embedded in the device or in the manufacturing cell to be able to compose the individual features (services), which is to say for the processor to carry out the service orchestration according to the composition rule set out in (1), which is exactly one of the central concepts of the invention:
An SoA-based procedure for monitoring purposes.
This processor is referred to hereinafter as the orchestrator O.

Each service orchestrator O in the SoA-based enterprise architecture is a monitor component in the SoA-based higher-level control system.

Model-based monitoring moves away from the characteristics directly supplied by the machine and focuses on the actual process while the machine carries out the activities required for the desired purpose and is shown in purely schematic form in FIGS. 4a, 4b.

The model of a process comprises the model parameters and the model properties, which represent the current state of the activity. This means that a process model contains the connections between the differing activities required for the process, together with the information required for this activity, such as the spraying of coolant at a predetermined pressure during a predetermined time.

By analyzing the model properties, new monitoring characteristics are generated from the model analysis which are made available as monitoring services WS4, WS6, WSd1, WSd2 via the web service interfaces WSId1, WSId2 associated with the components D1, D2 carrying out the process. A simple example shows the options this method has to offer: in a line in which a liquid flows, a pressure measuring system transmits the parameter “pressure” (P [Pascal]) and a second measuring system transmits the parameter “volume (V [m³]). The model of the line then follows the following law:

$$Z = \frac{P}{V}$$

where Z is the resistance of the line. In this case, the line model allows the variable Z to be determined as a monitoring characteristic.

Another example: If the information to be monitored for monitoring purposes is the electrical energy expended for a certain activity in a certain device, but this device does not contain a sensor which directly measures this variable, it is nonetheless possible to obtain this information by analyzing the data of other sensors that are present according to the corresponding physical/logical law of the process model in question. Assuming that the values for voltage and current are available, it is known according to the fundamentals of electrical engineering that:

E[Joules]=P[Watt]*t[seconds] (2)

P[Watt]=V[Volt]*I[Ampere] (3)

E=V*I*t (4)

Each service orchestrator O, O1, O2 in an SOA-based enterprise architecture is a monitoring system.

The software which is embedded in a smart hardware component K1, K2, K3, K4, K5, D1, D2, which is to say a device or system, independently of the level of the level of the SoA-based enterprise architecture, and which is responsible for the composition the model parameters according to the physical or logical law, is defined as the orchestrator O1, O2. The results of the orchestration or composition are made available as services WS6, WSd1, WSd2. The orchestrator (“orchestration engine” in FIG. 3 and FIG. 4) makes monitoring characteristics available and is thus referred to as an SoA-based monitor component.

Definition 1: The number of orchestration processes will be equal to the number of necessary monitoring functions, which is to say an orchestration process exists for each physical or logical law which is used to monitor a certain process.

Definition 2: The orchestration processes are carried out by one orchestrator or several orchestrators, which is to say by parts of or by the entire software embedded in one or more devices of the SoA-based automation architecture.

Definition 3: In accordance with the concept of the service bus, a smart device or system in the SOA-based industrial plant will have the capability of carrying out monitoring functions as services as soon as the associated orchestration process is uploaded according to the physical law for the process to be monitored. This physical/logical law is based on process models or on methods of qualitative sensor fusion. FIGS. 4a and 4b show the concept of model-based orchestration used for monitoring purposes.

By combining the two methods, it is possible to gain a much clearer view of the manufacturing cell FZ than with the use of conventional technologies.

Because both model- and feature-based characteristics are available as web services WS1, WS2, WS3, WSm, WSe, WSd1, WSd2, the task of combining them to obtain useful information is carried out by the additional composition and orchestration of these web services to form composed services of higher levels.

Each service orchestrator O, O1, O2 in the SOA-based enterprise architecture is a monitor system.

The software which is embedded in a small hardware component (a device or system, independently of the level of the SoA-based enterprise architecture) and which is responsible for the composition the model parameters according to the physical or logical law is defined as an orchestrator. The results of the orchestration or composition are made available as services. The orchestrator makes monitoring characteristics available and is thus referred to as an SoA-based monitor component.

The orchestrator O, O1, O2 can carry out model-based monitoring if the composition of the services (monitoring characteristics) follows a procedural physical or mathematical and/or logical law. The orchestrator O, O1, O2 can also carry out feature-based monitoring if it operates solely on the basis of events that are connected to feature-based characteristics, which is to say, for example, with sensor signals offered as services. Finally, the orchestrator O, O1, O2 can carry out a combination of these two monitoring methods.

Proceeding from the section above, some of the definitions can be formalized as follows:

Definition 4: Monitoring characteristics in an SoA-based environment are offered as web services WS1, WS2, WS3, WS4, WS5, WSd1, WSd2. The values of the differing characteristics are offered as methods or events via the web service interface WSI and the necessary composition is carried out by the composition these web services WS1, WS2, WS3, WS4, WS5. For this reason, they are defined as being equivalent.

Definition 5: Feature-based monitoring characteristics are web services WS1, WS2, WS3 offered by smart sensors. Smart sensors are such which are equipped with a web service interface WSI, which can offer sensor data via the SoA-based network.

Definition 6: Model-based monitoring characteristics are web services WSd1, WSd2 offered by orchestrators O1, O2 according to an orchestration method, which basically allows the formal composition of the monitoring functions.

Definition 7: The monitor orchestrator O1, O2 basically follows one or both of the following two procedures:
Signal composition, for example by way of sensor fusion, which yields a web service which couples individual web services to each other.
Process model, which yields a web service which couples the model parameters or functional processes, such as pneumatic power, to each other.

Every time a user or the higher-level SoA-based control system requires a specific monitoring characteristic which is connected to the process, the component behavior or the behavior of the architecture level, the orchestration monitor O1, O2 embeds a new service.

The method of service orchestration or composition in the monitor orchestrator O1, O2 follows one of the following three alternatives:
(I) response to a mathematical or physical or logical model (for example process law, physical law, and the like);
(II) response to a relationship which is based on experience or knowledge of the process to be monitored (for example qualitative model); and
(III) response to a combination of the two.

The orchestration monitors O1, O2 convert the monitoring characteristics into “services”. These services WS6, WSd1, WSd2 run jointly via the “service bus” SN of the SoA-based enterprise architecture. The capacity of the monitoring services to be present “jointly” on the service bus allows the higher-level control system IB, HMI to generate compositions of services which are offered at differing levels and by many different components of the SoA-based enterprise architecture.

Energy-related services, such as energy consumption, parameters of the energy efficiency, and the like, which are energy monitoring characteristics and not offered as services by smart devices, can be easily generated as a result of the method using monitoring orchestration (according to the aforementioned features). Example: The electrical energy consumed by space is orchestrated with the pneumatic energy consumed by the valve of a pump operating in this space.

FIGS. 4a, 4b show the procedure of the monitor orchestration for an SOA-based enterprise architecture.

A manufacturing cell FZ according to FIG. 5 is selected as the application case for the proposed method. It is thus possible to obtain production and energy data of existing machines and compare the data to the result expected from the use of the techniques according to the invention.

For this purpose, a CNC manufacturing cell FZ was selected. CNC manufacturing cells are composed of several functionally identical CNC machines M1, M2, M3, M4, M5, M6, which are supplied with material by one or more gantry conveyor systems PFA located thereabove. FIG. 5 shows an example of such a system. Because of this design, the machines can operate simultaneously and the work can thus be distributed during maintenance work or failure of a particular machine, allowing interruptions in the production operation to be prevented.

The advantage of selecting such a design for the present work can be summarized in the fact that while such a cell may be composed of many machines, these are functionally identical, with the exception of the gantry conveyor system. This saves time when it comes to the details of the implementation, and instead it is possible to focus on the SOA-based infrastructure. It is also advantageous that the machines M1, M2, M3, M4, M5, M6 in question were being closely monitored and the production data thereof, such as machining times and energy consumption, were analyzed in detail.

In light of the rising trend to employ production means that can be universally applied, such as CNC machines, it is assumed that the results of the use of the methods described here can be translated to modern production plants.

The design of the manufacturing cell FZ depicted in FIG. 5 clearly shows that the criterion for selecting smart devices to be developed is only met by those devices which can automatically fulfill the functionality thereof. For the cell design in question, this means that the functionality of smart devices is implemented in each CNC machine M1, M2, M3, M4, M5, M6 and in the gantry conveyor system PFA.

The feed conveyor belt could likewise be equipped with a web service functionality, however in the present case that is analyzed this is dispensed with, because this belt interfaces with other neighboring cells of the manufacturing line. Because the concept necessitates a cell to be treated in an isolated manner, the integration of the further conveyor system of the overall plant is outside the scope of the present embodiment.

A simple web service may be used for testing and simulation purposes so as to inform the gantry conveyor system about the arrival of new workpieces.

The required web services WS are selected in two stages: a top-down method and a bottom-up method.

In the top-down method, first the functions which are required for the monitoring system are established. These functions, such as the energy consumption, as presented in equation (2), are broken down into the individual compositional characteristics thereof such that they match the characteristics which are offered by the characteristics available in the smart devices.

The bottom-up method is used to select the models equipped with web service interfaces WSI and to find out how these can be composed to form useful monitoring characteristics. This method checks whether and how the sensor characteristics in machines M1, M2, M3, M4, M5, M6 can be coupled and how this composition results in monitoring characteristics for complete manufacturing cells FZ.

The above description defines monitoring characteristics as being equivalent to web services. Equations (2), (3) and (4) presented above, for example, show that the described characteristics can be replaced with web services WS. This is shown in FIG. 6, where the composition of the differing features is identical to the composition of the web services.

This applies to all types of monitored features and can therefore be generalized as follows:

F=F₁·F₂·F₃· . . . ·Fᵢ· . . . ·Fₙ (5)

[symbol]

WS=WS₁·WS₂·WS₃· . . . ·WSᵢ· . . . ·WSₙ (6)

By using the two methods, it is possible to select the necessary components of the monitoring system and utilize them in order to implement the necessary orchestration of web services described in equation (6).

The result of these developments is a fully functional SoA-based monitoring system.

The emergence of the SoA paradigm in manufacturing automation constitutes a significant help to the manufacturers, who must face today's industrial challenges. The availability of SoA-based smart devices with associated, or even integrated, monitoring services gives manufacturing engineers a new unobstructed view of the manufacturing system. This opens up new paths toward the visualization of the development of manufacturing lines by making available a visualization of the manufacturing status in real time which is more precise in terms of the details thereof.

Using the methods presented in this document allows the development of a complete monitoring system which is able to track the status of a manufacturing cell in a much more detailed manner than is possible with the presently typically available monitoring systems.

While the majority of energy-related examples presented in this document concern electrical energy, the same principles can also be applied to different forms of energy consumption. This applies whenever the energy characteristics, such as media pressure and flow rate, temperature, pneumatics and the like, are measurable.

It could moreover be argued that the proposed method poses a problem due to the exorbitantly high costs for equipping every sensor and every small hardware component with web services. However, it is not true that the web service must be implemented locally at the level of each hardware sensor, for example, but instead it can also be set up on a central web service host computer, which combines the sensor signals and offers the respective web service interfaces. This is possible due to the linked design of the web services. Because each web service interface would be hosted independently via the network, the original concept of autonomous smart sensors as autonomous units would in fact be preserved.

The invention relates to a procedure for making feature- and model-based monitoring characteristics available as results of the orchestration of monitoring services in an SoA-based industrial environment.

The invention is characterized by one or more of the following features:

Each service orchestrator in the SoA-based enterprise architecture is a monitor component within an SoA-based higher-level control system, and/or

the software which is embedded in a smart hardware component (a device or system, independently of the level of the SoA-based enterprise architecture) and which is responsible for composing the model parameters according to the physical/logical law is defined as an orchestrator, and/or

the result of the orchestration or composition is offered as a service, and/or

the orchestrator (“orchestration engine” in FIG. 3 and FIG. 4) makes monitoring characteristics available and is thus referred to as an SoA-based monitor component, and/or

the orchestrator can carry out model-based monitoring if the composition of the services (monitoring characteristics) follows a procedural or physical or mathematical or logical law (model), and/or

the orchestrator can also carry out feature-based monitoring if it operates solely on the basis of events that are connected to feature-based characteristics, for example, with sensor signals offered as services, and/or

the orchestrator can carry out a combination of these two monitoring methods, and/or

every time a user or the higher-level SOA-based control system requires a specific monitoring characteristics which is connected to the process, the component behavior or the behavior of the architecture level, the orchestration monitor embeds a new service, and/or

the method of service orchestration or composition behind the monitor orchestrator follows one of the following three alternatives:
(I) response to a mathematical or physical or logical model (for example process law, physical law, and the like);
(II) response to a relationship which is based on experience or knowledge of the process to be monitored (for example qualitative model); and
(III) response to a combination of the two;
   and/or

the orchestration monitors convert the monitoring characteristics into “services”.

These services run jointly via the “service bus” of the SoA-based enterprise architecture. The capacity of the monitoring services to be present “jointly” on the service bus allows the higher-level control system to generate compositions of services which are offered at differing levels and by many different components of the SOA-based enterprise architecture;

and/or

energy-related services, such as energy consumption, parameters of the energy efficiency, and the like, which are energy monitoring characteristics and not offered as services by smart devices, can be easily generated as a result of the method using monitoring orchestration (according to the aforementioned features).

Example: The electrical energy consumed by space is orchestrated with the pneumatic energy consumed by the valve of a pump operating in this space.

Table for FIG. 1 - Design of enterprise architectures:

| | | TIME FRAME for |
|---|---|---|
| | | response |
| | | resolution |
| | | reliability |
| LEVEL | APPLICATION | repairability |
| LEVEL 5 | PRODUCTION PLANNING | DAYS |
| | ACCOUNTING | up to |
| | SUPPLIER ASSESSMENT | WEEKS |
| | COMPUTER-AIDED DRAFTING & DESIGN | |
| | MAINTENANCE COST DETERMINATION | |
| LEVEL 4 | PRODUCTION SCHEDULING | HOURS |
| | MAINTENANCE SCHEDULING | up to |
| | PLANNING OF MANUFACTURING RESOURCES | DAYS |
| | TRACKING OF MATERIAL/PRODUCTS | |
| | SITEWITE PRODUCTION REPORTING | |
| LEVEL 3 | DEPARTMENT OPTIMIZATION | MINUTES |
| | PRODUCTION DATA HISTORY | up to |
| | MAINTENANCE MONITORING | HOURS |
| LEVEL 2 | USER INTERFACE | SECONDS |
| | UNIT OPTIMIZATION | up to |
| | TREND DETECTION (REPLACING RECORDER) | MINUTES |
| LEVEL 1 | CONTROL | MILLISECONDS |
| | INTERLOCKING | up to |
| | | SECONDS |
| LEVEL 0 | SENSORS | CONSTANTLY |
| | ACTUATORS | |

### REFERENCE LIST FOR FIG. 1

### Design of Enterprise Architectures

1 Typical enterprise systems architecture
2 COOPERATIVE ENGITECH
3 COOPERATIVE DPMIS
4 FINAN. CONS.
5 EIS
6 PLANNING
7 ENG
8 LOCAL ENG & TECH
9 MAINT. MGT
10 ENG & CAC
11 LOCAL MIS
12 A/P
13 A/R
14 G/L
15 H/L
16 SALARIES
17 ORDER ENTRY
18 SHIPPING
19 R OCCUR
20 WIDE AREA NETWORK
21 OFFICE LAN
22 MAINTENANCE SCHEDULING
23 SITEWIDE DATABASE
24 MES
25 QUALITY MANAGEMENT
26 RAW MATERIALS & FIG. OR ODS TRACKING
27 PRODUCTION SCHEDULING & REPORTING
28 SITEWIDE INDUSTRIAL LAN
29 LAD SYSTEMS
30 PROCESS AREA SUPERV.
31 CUSTODY TRANSFER STORAGE
32 PACKAGING/HANDLING
33 POWER HOUSING SUPERV.
34 WAREHOUSE AUTOMATION
35 OPER. DISPLAY
36 OPER. DISPLAY
37 PROPRIETARY DSC AND FLC NETWORKS
38 CONTROLLER, PLCs, DATA ACQUISITION DEVICES, ETC.

1-18. (canceled)

19. A method for providing monitoring characteristics in an SoA-based industrial environment for monitoring changes in state of a process and/or of production means (PM) of an industrial plant, the changes in state being obtained by analyzing feature-based monitoring characteristics, such as sensor signals, which are provided as services (S1 . . . Sn; WS1, WS2, WS3) by components to be monitored as monitoring components (K1, K2, K3, K4, K5), such as sensors of the industrial plant, wherein:
the feature-based monitoring characteristics provided as services (S1 . . . Sn; WS1, WS2, WS3) by the monitoring components (K1, K2, K3, K4, K5) of the industrial plant are orchestrated by means of service orchestrators (O, O1, O2), which are implemented as software modules in monitoring components (K1, K2, K3, K4, K5) and control systems (DB, HMI, IB, D1, D2) distributed at differing levels (SL, ML, EL) of the SoA-based industrial environment, to form new model-based monitoring characteristics (F1) which are not made available by existing monitoring components,
the orchestration of the services (S1 . . . Sn; WS1, WS2, WS3) is carried out according to one or more physical or logical law(s) of a process model of the industrial plant,
each of the service orchestrators (O, O1, O2) forms a new monitoring component (D1, D2) in the SoA-based industrial environment and offers the at least one new model-based monitoring characteristic as a service (WSd1, WSd2), and
the feature- and model-based monitoring characteristics offered by the monitoring components (K1, K2, K3, K4, K5, D1, D2) as services (WS1, WS2, WS3, WSd1, WSd2) at differing levels of the SoA-based industrial environment are provided via a service-oriented network (SN) for random composition in a control system (D1, D2, IM; HMI; DB) comprising a service orchestrator.

20. The method according to claim 1, wherein the orchestration is carried out by the software which is preferably embedded in one or more of the components and forms the service orchestrator (O, O1, O2).

21. The method according to claim 19, wherein a dedicated orchestration process is carried out for each physical or logical law which is used for monitoring a certain process.

22. The method according to claim 19, wherein the orchestration is carried out by one or more distributed orchestrators (O, O1, O2), which is to say by parts of or by the entire software which are or is embedded in one component (D1, D2), or in several components (D1, D2), of the SoA-based architecture.

23. The method according to claim 19, wherein the software which forms the sensor orchestrator and carries out the orchestration according to a physical or logical law for the process to be monitored can be uploaded to the SoA-based component (K1, K2, K3, K4, K5, D1, D2).

24. The method according to claim 19, wherein the physical or logical law is derived from a process model or is based on the method of qualitative service fusion.

25. The method according to claim 19, wherein the process model comprises model parameters and model properties, wherein the new monitoring characteristics are generated by analyzing the model properties and these new monitoring characteristics are then made available via the web service interfaces that are part of the components carrying out the process.

26. The method according to claim 19, wherein the service orchestrator (O, O1, O2) carries out model-based monitoring if the composition of the services, which is to say of the monitoring characteristics, follows a procedural physical or mathematical or logical law.

27. The method according to claim 19, wherein the service orchestrator (O, O1, O2) carries out feature-based monitoring if it operates on the basis of events that are connected to feature-based characteristics, which is to say with the data from the sensor signals offered as services.

28. The method according to claim 19, wherein the feature-based monitoring characteristics of smart sensors (K1, K2, K3) are offered as services, wherein smart sensors are such which are equipped with a service interface (WSI1, WSI2, WSI3, WSI4, WSI5, WSI6), which offers sensor data via the SoA-based network.

29. The method according to claim 19, wherein model-based monitoring characteristics are offered by the orchestrators (O, O1, O2) as a service according to an orchestration method.

30. The method according to claim 19, wherein the service orchestrator as an orchestration monitor generates a new service which couples individual services with each other, using signal composition, for example sensor fusion, or using the process model which supplies a service which couples model parameters or functional processes, such as pneumatic power, with each other.

31. The method according to claim 19, wherein the service orchestration in the service orchestrator is carried out based on one of the following approaches:
a mathematical or physical or logical quantitative model;
knowledge of the process to be monitored in the form of a qualitative model, for example; and/or
a combination of a) and b).

32. The method according to claim 19, wherein the services are offered in real time.

33. A system for providing monitoring characteristics in an SoA-based industrial environment for monitoring changes in state of a process and/or of production means (PM) of an industrial plant, the changes in state being obtained by analyzing feature-based monitoring characteristics, such as sensor signals, which are provided as services (S1 . . . Sn; WS1, WS2, WS3, WSd1, WSd2) by components to be monitored as monitoring components (K1, K2, K3, K4, K5), such as sensors of the industrial plant, wherein:
the feature-based monitoring characteristics provided as services (S1 . . . Sn; WS1, WS2, WS3, WSd1, WSd2) by the monitoring components (K1, K2, K3, K4, K5) of the industrial plant can be orchestrated by means of service orchestrators (O, O1, O2), which are implemented as software modules in monitoring components (K1, K2, K3, K4, K5) and control systems (DB, HMI, IB; D1, D2) distributed at differing levels (SL, ML, EL) of the SoA-based industrial environment, to form new model-based monitoring characteristics (F1) which are not made available by existing monitoring components,
the orchestration of the services (S1 . . . Sn; WS1, WS2, WS3, WSd1, WSd2) can be carried out according to one or more physical or logical law(s) of a process model of the industrial plant,
each of the service orchestrators (O, O1, O2) forms a new monitor component (D1, D2) in the SoA-based industrial environment and offers the at least one new model-based monitoring characteristic (WSd1, WSd2) as a service, and
the feature- and model-based monitoring characteristics offered as services by the monitoring component at differing levels of the SoA-based industrial environment can be provided via a service-oriented network (SN) for random composition in a control system comprising a service orchestrator (O, O1, O2).

34. The system according to claim 33, wherein the software forming the service orchestrator (O1, O2) is preferably embedded in one or more of the components (K1, K2, K3, K4, K5, D1, D2, HMI, IB).

35. The system according to claim 33, wherein the software which forms the sensor orchestrator (O1, O2) and carries out the orchestration according to a physical or logical law for the process to be monitored can be uploaded to the SoA-based component.

36. The system according to claim 33, wherein the feature-based monitoring characteristics of smart sensors are offered as services, wherein smart sensors are such which are equipped with a service interface, which offers sensor data via the SoA-based network.
